(19) United States
(12) Patent Application Publication
(10) Pub. No.: US 2015/0161597 A1
(43) Pub. Date: Jun. 11, 2015

(54) TRANSACTIONS USING TEMPORARY CREDENTIAL DATA

(71) Applicants: Kaushik Subramanian, Fremont, CA (US); Thanigaivel Ashwin Raj, Foster City, CA (US); Uzma Makhdumi, Foster City, CA (US); Bradley Greene, Burlingame, CA (US)

(72) Inventors: Kaushik Subramanian, Fremont, CA (US); Thanigaivel Ashwin Raj, Foster City, CA (US); Uzma Makhdumi, Foster City, CA (US); Bradley Greene, Burlingame, CA (US)

(21) Appl. No.: 14/565,066

(22) Filed: Dec. 9, 2014

Related U.S. Application Data
(60) Provisional application No. 61/913,826, filed on Dec. 9, 2013.

(51) Int. Cl. G06Q 20/36; G06Q 20/40

(52) U.S. Cl. CPC G06Q 20/3674; G06Q 20/40

(57) ABSTRACT

A method is disclosed. The method includes receiving a credential request message requesting a temporary credential associated with a payment account, and then determining, by a server computer, using a routing table and data associated with the payment card, a third-party computer associated with the payment account. The method also includes transmitting the credential request message to the third-party computer, and receiving, by the server computer, the temporary credential from the third-party computer. The method also includes determining, by the server computer, the communication device associated with the requested temporary credential and transmitting, by the server computer, the temporary credential to the communication device.

### CROSS-REFERENCES TO RELATED APPLICATIONS

This application is a non-provisional application of and claims the benefit of priority to U.S. Provisional Application No. 61/913,826, filed on Dec. 9, 2013, which is herein incorporated by reference in its entirety for all purposes.

### BACKGROUND

The use of virtual wallets running on communication devices has gained increased attention in the last few years as an alternative to carrying around physical payment cards. Many virtual wallet applications allow users to complete transactions using one-time payment credentials, for example tokens, using his/her communication device. Many large banks and payment providers have already implemented support for one-time payment credentials associated with the user's primary account number (PAN).

However, current virtual wallet application solutions interface directly with issuers of the user's payment cards. Since, typically, a user may have more than one payment card they wish to enroll and use with the virtual wallet application, the virtual wallet application needs to have the capability to interface with a large amount of issuers or merchants and understand specific protocols when requesting the one-time payment credentials. This is an inefficient implementation because it creates unnecessary processing expense and complexity for the virtual wallet application and the communication device.

Embodiments of the invention address this and other problems, individually and collectively.

### BRIEF SUMMARY

In some embodiments of the invention, systems and methods facilitating mobile payment transactions using temporary payment credential data are provided. Embodiments of the invention are directed to a mobile platform that functions as a “switch” in between a payment device (e.g., communication device) and one or more third party computers that can provide the payment credentials. Currently, when a user wishes to initiate a transaction that uses temporary payment credentials, the payment device communicates directly with a third party computer to obtain the temporary payment credential. This is not efficient, because the payment device requires a line of communication with many different third parties and needs to understand each third party's unique credential algorithm.

One embodiment of the invention is directed to a method. The method includes receiving a credential request message requesting a temporary credential associated with a payment account, and then determining, by a server computer, using a routing table and data associated with the payment card, a third-party computer associated with the payment account. The method also includes transmitting the credential request message to the third-party computer, and receiving, by the server computer, the temporary credential from the third-party computer. The method also includes determining, by the server computer, the communication device associated with the requested temporary credential and transmitting, by the server computer, the temporary credential to the communication device.

One embodiment of the invention is directed to another method. The method includes receiving, from a communication device, a credential request message requesting a temporary credential associated with a predetermined amount, and then transmitting, by a server computer, an authorization hold request message. The method also includes receiving an authorization hold response message, and providing, by the server computer, the temporary credential to the communication device.

Other embodiments of the invention are directed to communication devices, servers, and systems that are configured to perform the above-described methods.

These and other embodiments of the invention are described in further detail below.

### BRIEF DESCRIPTION OF THE DRAWINGS

FIG. 1 shows a block diagram of a transaction processing system.

FIG. 2 shows a block diagram of a communication device.

FIG. 3 shows a block diagram of a server computer.

FIG. 4 shows a flow diagram of consumer enrollment with a mobile payment platform.

FIG. 5 shows a flow diagram of a payment credential request to a mobile payment platform.

FIG. 6 shows a flow diagram illustrating steps of a payment transaction using a QR code with the mobile payment platform.

FIG. 7 shows a flow diagram illustrating steps of an alternative embodiment for a payment transaction using a QR code with the mobile payment platform.

FIG. 8 shows a flow diagram illustrating steps of an alternative embodiment for a payment transaction using a QR code with the mobile payment platform.

FIG. 9 shows a flow diagram illustrating steps of another alternative embodiment for a payment transaction using a QR code with the mobile payment platform.

FIG. 10 shows an exemplary routing table for routing requests for one-time payment credentials to an appropriate third-party.

FIG. 11A is a flowchart of an exemplary method for enrolling an item in a virtual wallet.

FIG. 11B is a flowchart of an exemplary method for transmitting a hold request for a predetermined amount.

FIG. 12 shows a block diagram of a computer apparatus.

### DETAILED DESCRIPTION

Embodiments are directed at systems, methods, and devices for facilitating a payment transaction using a one-time credential. A mobile platform server can act as a “switch” for routing requests for registration and requests for one-time payment credentials to appropriate third-party entities. These third-party entities can include, but is not limited to, issuers and merchants. The mobile platform server can access a routing table to determine the appropriate third-party based on information received from a communication device that is making the request. Accordingly, the communication devices do not need to be able to communicate with a vast amount of different third-parties and understand their various encoding algorithms or third-party specific communication formatting in order to make the request.

Prior to discussing embodiments of the invention, descriptions of some terms may be helpful in understanding embodiments of the invention.

“Authentication” is a process by which the credential of an endpoint (including but not limited to applications, people, devices, processes, and systems) can be verified to ensure that the endpoint is who they are declared to be.

An “original” transaction may include any transaction including an authorization provided by an issuer or an authorization provided on-behalf-of an issuer.

A “substitute” transaction may be any transaction that is associated with an original transaction and that takes place after the original transaction, including repeat, refunds, reversals or exceptions (chargebacks, re-presentments, etc.).

An “end-user” may include any application, device, consumer, or system that is configured to interact with a requestor for tokenization/de-tokenization/token management services. For example, an end-user may include a consumer, a merchant, a mobile device, or any other suitable entity that may be associated with a requestor in the network token system.

A “consumer” may include an individual or a user that may be associated with one or more personal accounts and/or consumer devices. The consumer may also be referred to as a cardholder, accountholder, or user.

A “card-on-file (COF)” holder may include any entity that stores account details (e.g., card details, payment account identifiers, PANs, etc.) for use in transactions. For example, a COF entity may store payment information on file for various types of periodic payments such as monthly utility payments, periodic shopping transactions, or any other periodic or future transaction. Because payment credentials and/or associated tokens are stored at an entity for a future transaction, the transactions initiated by a COF entity include card-not-present (CNP) transactions. Another type of card-not-present (CNP) transaction includes e-commerce or electronic commerce transactions that are initiated between remote parties (e.g., a consumer device and a merchant web server computer).

An “authorization request message” may be an electronic message that is sent to a payment processing network and/or an issuer of a payment account to request authorization for a transaction. An authorization request message is an example of a transaction message. An authorization request message according to some embodiments may comply with ISO 8583, which is a standard for systems that exchange electronic transaction information associated with a payment made by a consumer using a payment device or a payment account. In some embodiments of the invention, an authorization request message may include a payment token (e.g., a substitute or pseudo account number), an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include an authorization code, which may be a code that a credit card issuing bank returns in response to an authorization request message in an electronic message (either directly or through the payment processing network) to the merchant's access device (e.g. POS terminal) that indicates approval of the transaction. The code may serve as proof of authorization. As noted above, in some embodiments, a payment processing network may generate or forward the authorization response message to the merchant.

An “authorization hold request message” may be similar to an authorization request message except that instead of including a transaction amount for authorization of the transaction, the authorization hold request message may include a hold amount to place a hold on the user's payment account.

An “authorization hold response message” may be similar to an authorization response message but instead may be an electronic message reply to an authorization hold request message.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer.

An “access device” can include a device that allows for communication with a remote computer, and can include a device that enables a customer makes a payment to a merchant in exchange for goods or services. An access device can include hardware, software, or a combination thereof. Example of access devices include point-of-sale (POS) terminals, mobile phones, laptop or desktop computers, etc.

A “virtual wallet” or “digital wallet” refers to an electronic device that allows an individual to make electronic commerce transactions. This can include purchasing items on-line with a computer or using a communication device (e.g., smartphone) to purchase an item at a physical store. The “virtual wallet” or “digital wallet” can consist of the system (the electronic infrastructure), the application (the software that operates on top), and the device (the individual portion). An individual's bank account can also be linked to the virtual wallet. The individual may also have their driver's license, health card, loyalty card(s), and other ID documents stored within the virtual wallet.

A “virtual wallet provider” or “digital wallet provider” may include any suitable entity that provides a virtual wallet service or digital wallet service. A virtual wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the virtual wallet.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

A “third-party” can include any party involved in a transaction that is not a first party such as a consumer and a second party such as a merchant. Third parties may include, without limitation, issuers, acquirers, digital wallet providers, coupon providers, shipping providers, etc.

A “temporary credential” may include data that is temporary and can allow access to a particular resource. Examples of temporary credentials include offers that have limited duration, payment tokens of limited duration, verification values of limited duration, etc. Credentials may last or be effective for a predetermined time or duration when they are temporary. For example, a credential may only be used one time, and may be ineffective after that use. In another example, a credential may be used multiple times, but may only be used during a specified time period (e.g., one day).

An “offer” or a “discount” or a “coupon” may include any incentive or reward from a third-party, such as a merchant, issuer, digital wallet provider, payment service provider, shipping provider, or other entity associated with a transaction. The offer or discount or coupon may apply to a particular transaction based on the specifics of the transaction and/or the account being used in the transaction.

A “token” may include a substitute identifier for some information. For example, a payment token may include an identifier for a payment account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token. A token may be a type of “temporary credential.”

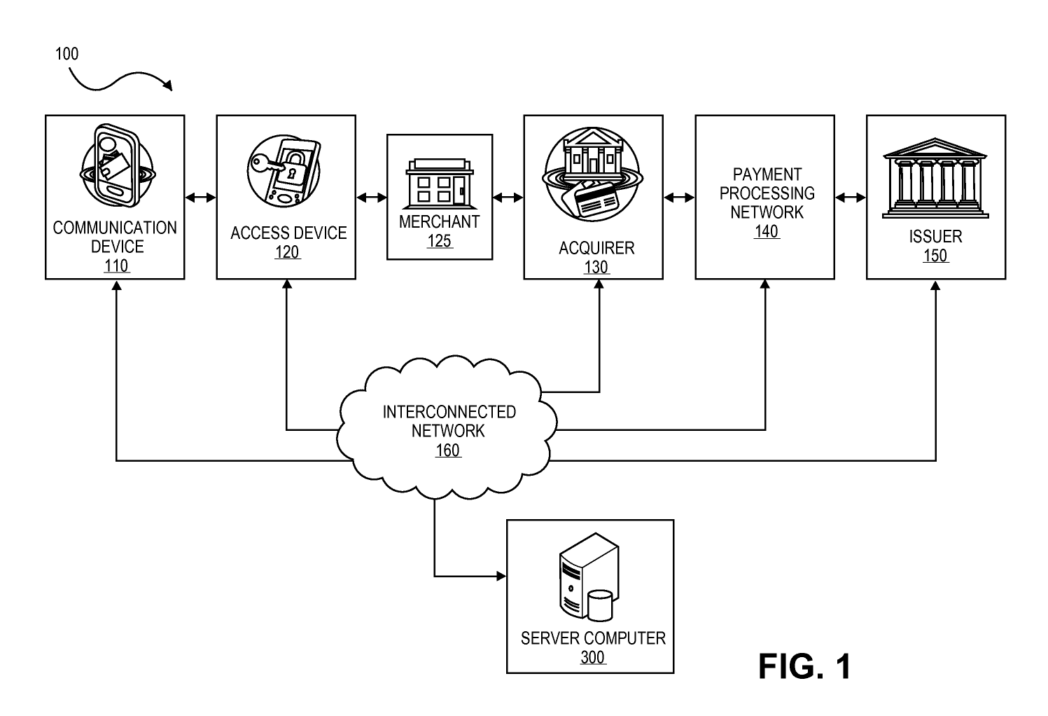

FIG. 1 shows a block diagram of a typical transaction processing system 100 for electronic payment transactions using issuer accounts, in accordance with some embodiments of the invention.

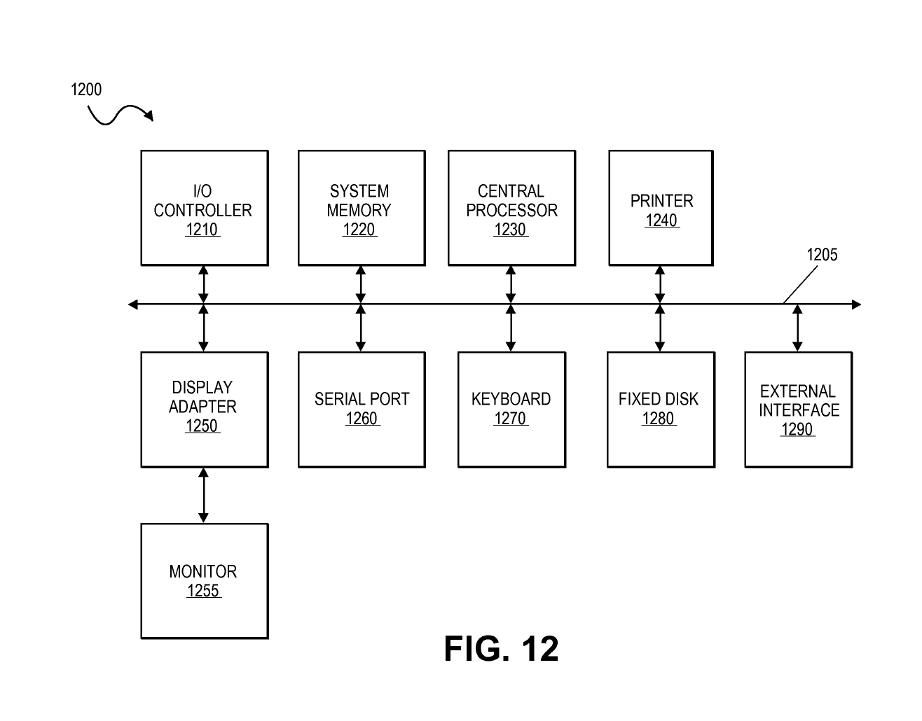

The system 100 may include a communication device 110, an access device 120, a merchant computer 125, an acquirer computer 130, a payment processing network computer 140, an issuer computer 150, and a server computer 300. In some implementations, different entities in FIG. 1 may communicate with each other using one or more communication networks such as the Internet, a cellular network, a TCP/IP network or any other suitable communication network. Note that one or more entities in the system 100 may be associated with a computer apparatus that may be implemented using some of the components as described with reference to FIG. 12.

The communication device 110 may be associated with a payment account of a user. In some implementations, the communication device 110 may be a mobile device such as a mobile phone, a tablet, a PDA, a notebook, a key fob or any suitable mobile device. For example, the communication device 110 may include a virtual wallet or a payment application that may be associated with one or more payment accounts of the user. In some implementations, the communication device 110 may be capable of communicating with the access device 120 using a short range communication technology such as NFC. For example, the communication device 110 may interact with the access device 120 by tapping or waving the consumer device 110 in proximity of the access device 120. In some implementations, the communication device 110 may be a payment card such as a credit card, debit card, prepaid card, loyalty card, gift card, etc.

The access device 120 may be an access point to a transaction processing system that may comprise the acquirer computer 130, the payment processing network computer 140, and the issuer computer 150. In some implementations, the access device 120 may be associated with or operated by the merchant computer 125. For example, the access device 120 may be a point of sale device that may include a contactless reader, an electronic cash register, a display device, etc. In some implementations, the access device 120 may be configured to transmit information pertaining to one or more purchased items at a merchant 125 to an acquirer 130 or payment processing network 140. In some implementations, the access device 120 may be a personal computer that may be used by the user to initiate a transaction with the merchant computer 125 (e.g., an online transaction).

The merchant computer 125 may be associated with a merchant. In some embodiments, the merchant computer 125 may be associated with a card-on-file (COF) merchant. For example, the card-on-file merchant may store consumer account information on file (e.g., at a merchant database) for future payment purposes such as various types of periodic payments (e.g., monthly utilities payments). In some implementations, a consumer may register with one or more merchants for card-on-file services. The merchant computer 125 may be configured to generate an authorization request for a transaction initiated by the user using the access device 120.

The acquirer computer 130 may represent a traditional acquirer/acquirer processor. The acquirer is typically a system for an entity (e.g., a bank) that has a business relationship with a particular merchant, a wallet provider or another entity. The acquirer computer 130 may be communicatively coupled to the merchant computer 125 and the payment processing network 140 and may issue and manage a financial account for the merchant. The acquirer computer 130 may be configured to route the authorization request for a transaction to the issuer computer 150 via the payment processing network computer 140 and route an authorization response received via the payment processing network computer 140 to the merchant computer 125.

The payment processing network computer 140 may be configured to provide authorization services, and clearing and settlement services for payment transactions. The payment processing network computer 140 may include data processing subsystems, wired or wireless networks, including the internet. An example of the payment processing network computer 140 includes VisaNet™, operated by Visa®. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. The payment processing network computer 140 may include a server computer. In some implementations, the payment processing network computer 140 may forward an authorization request received from the acquirer computer 130 to the issuer computer 150 via a communication channel. The payment processing network computer 140 may further forward an authorization response message received from the issuer computer 150 to the acquirer computer 130.

The issuer computer 150 may represent an account issuer and/or an issuer processor. Typically, the issuer computer 150 may be associated with a business entity (e.g., a bank) that may have issued an account and/or payment card (e.g., credit account, debit account, etc.) for payment transactions. In some implementations, the business entity (bank) associated with the issuer computer 150 may also function as an acquirer (e.g., the acquirer computer 130).

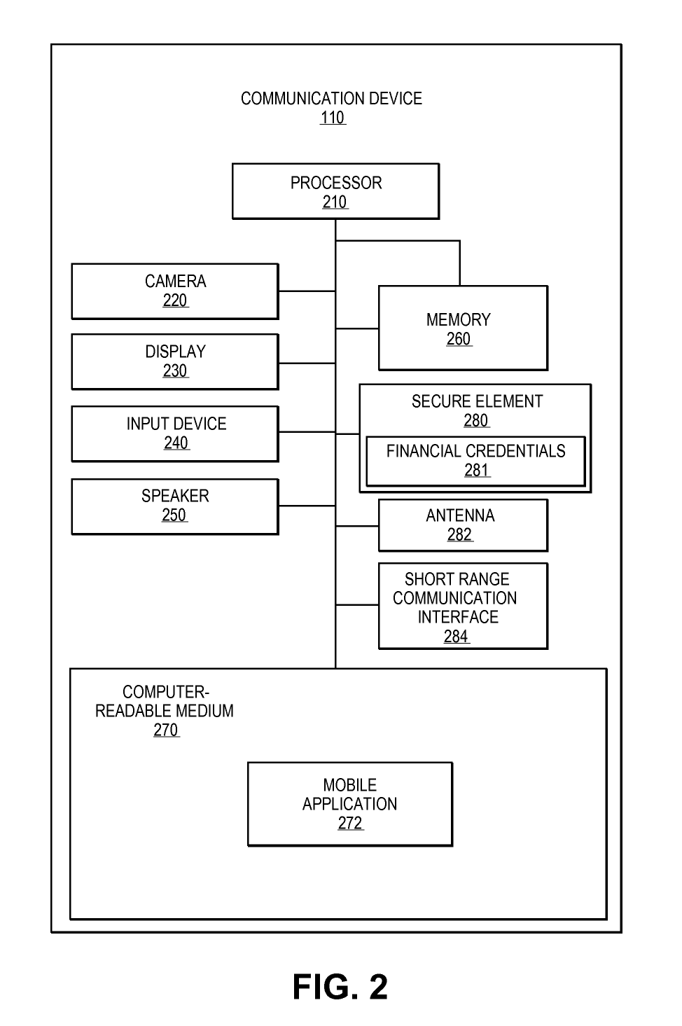

FIG. 2 shows a block diagram of a communication device 110, in accordance with some embodiments of the invention. Communication device 110 includes a processor 210, a camera 220, a display 230, an input device 240, a speaker 250, a memory 260, a secure element 280, an antenna 282 for long range communication, and a short range communication interface 284 for short range communication, and a computer-readable medium 270.

Processor 210 may be any suitable processor operable to carry out instructions on the communication device 110. The processor 210 is coupled to other units of the communication device 110 including camera 220, display 230, input device 240, speaker 250, memory 260, secure element 280, antenna 282, short range communication interface 284, and computer-readable medium 270.

Camera 220 may be configured to capture one or more images via a lens located on the body of communication device 110. The captured images may be still images or video images. The camera 220 may include a CMOS image sensor to capture the images. Various applications (e.g., mobile application 272) running on processor 210 may have access to camera 220 to capture images. It can be appreciated that camera 220 can continuously capture images without the images actually being stored within communication device 110. Captured images may also be referred to as image frames. In some embodiments, the camera 220 may be operable to capture an image of a QR code displayed on the access device 120.

Display 230 may be any device that displays information to a user. Examples may include an LCD screen, CRT monitor, or seven-segment display.

Input device 240 may be any device that accepts input from a user. Examples may include a keyboard, keypad, mouse, or microphone. In the case of a microphone, the microphone may be any device that converts sound to an electric signal. In some embodiments, the microphone may be used to capture one or more voice segments from a user.

Speaker 250 may be any device that outputs sound to a user. Examples may include a built-in speaker or any other device that produces sound in response to an electrical audio signal. In some embodiments, speaker 250 may be used to request the user for a voice sample for purposes of authentication.

Memory 260 may be any magnetic, electronic, or optical memory. It can be appreciated that memory 260 may include any number of memory modules. An example of memory 260 may be dynamic random access memory (DRAM).

Computer-readable medium 270 may be any magnetic, electronic, optical, or other computer-readable storage medium. Computer-readable storage medium 270 includes mobile application 272. Computer-readable storage medium 270 may comprise any combination of volatile and/or non-volatile memory such as, for example, buffer memory, RAM, DRAM, ROM, flash, or any other suitable memory device, alone or in combination with other data storage devices.

Mobile application 272 can be any application executable by processor 210 on the communication device 110. In some embodiments, the mobile application 272 can be a secure application for facilitating payment transactions using the communication device 110. For example, the mobile application 272 can be a digital wallet application. The mobile application 272 can interface with the secure element 280 to obtain the financial credentials 281 associated with the user. The mobile application 272 may contain, but is not limited to, the following core pieces: (1) a payment library including code for enabling payments including selecting and presenting the secure element 280 to the access device 120; (2) a proxy applet managed by a service provider that manages secure communications between the secure element 280 and a trusted service manager to execute account provisioning and account management commands; and (3) a contactless gateway library that includes code for enabling secure communication between the secure element 280 and a payment processor's contactless gateway.

The antenna 282 can allow the communication device to communicate with the server computer 300.

The short range communication interface 284 may be a contact or contactless interface. It may allow the communication device 110 to communicate with an access device (POS terminal) at a merchant. The short range communication interface 284 may include electrical contacts for contact based communication, or may include a contactless element. Suitable contactless elements may include RF ID devices that allow the communication device 110 to communicate with an access device using RF signals.

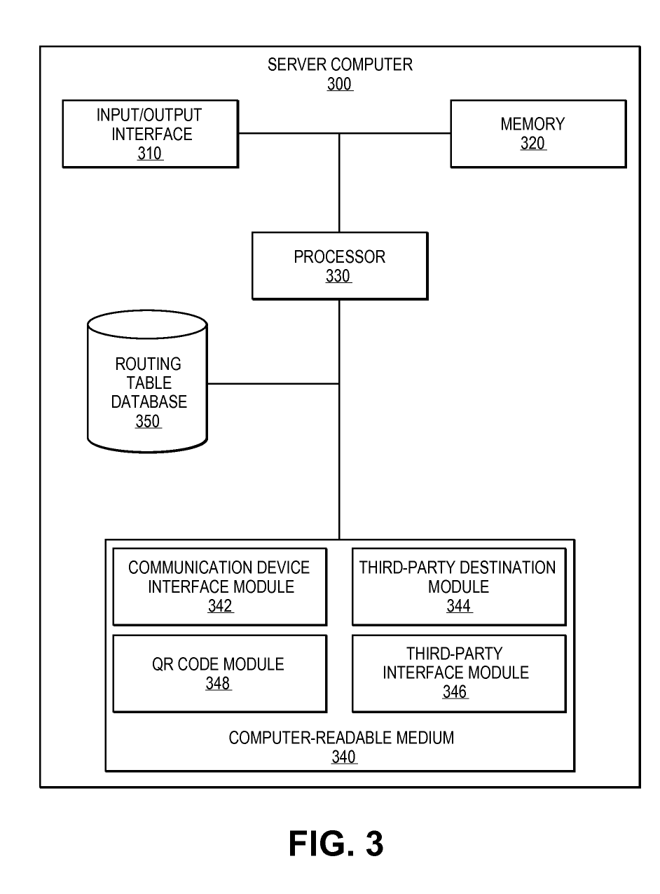

FIG. 3 is a block diagram of a server computer 300, according to some embodiments of the present invention. Server computer 300 includes an input/output interface 310, a memory 320, a processor 330, routing table database 350, and a computer-readable medium 340. In some embodiments, the server computer 300 may reside within the interconnected network 160 (FIG. 1). In some embodiments, the server computer 300 may reside within or be in communication with the payment processor network 140 (FIG. 1). It may alternatively or additionally be present at a merchant, issuer, or a suitable payment processor.

The input/output (I/O) interface 310 is configured to allow the server computer 300 to receive and transmit data, from any of the entities shown in FIG. 1.

Memory 320 may be any magnetic, electronic, or optical memory. It can be appreciated that memory 320 may include any number of memory modules, that may comprise any suitable volatile or non-volatile memory devices. An example of memory 320 may be dynamic random access memory (DRAM).

Processor 330 may be any suitable processor operable to carry out instructions on the server computer 300. The processor 330 is coupled to other units of the server computer 300 including input/output interface 310, memory 320, and computer-readable medium 340.

Computer-readable medium 340 may be any magnetic, electronic, optical, or other computer-readable storage medium. Computer-readable storage medium 340 includes communication device interface module 342, third-party determination module 344, third-party interface module 346, and QR code module 348. Computer-readable storage medium 340 may comprise any combination of volatile and/or non-volatile memory such as, for example, buffer memory, RAM, DRAM, ROM, flash, or any other suitable memory device, alone or in combination with other data storage devices.

Communication device interface module 342, can comprise code that when executed by the processor, can cause the processor 330 in the server computer 300 to send and receive communications between the communication device 110 (FIG. 1). For example, the communication device interface module 342 may be capable of handling a request received from the communication device 110 (FIG. 1) for user registration or a request for a one-time payment credential to be used by the communication device 110 (FIG. 1) in a payment transaction. The communication device interface module 342 may also transmit the one-time payment credential to the communication device 110 (FIG. 1).

Third-party determination module 344, can comprise code that when executed by the processor 330, can cause the server computer 300 to determine an appropriate third-party for a registration or one-time payment credential request received by the communication device interface module 342 from the communication device 110 (FIG. 1). The third-party determination module 344 may interface with the routing table database 350 (described below) to perform a lookup operation to determine the appropriate third-party for routing the registration or one-time payment credential request received by the communication device interface module 342 from the communication device 110 (FIG. 1). The third-party may perform the lookup, for example, using the primary account number (PAN) or an identifier identifying the communication device 110 (FIG. 1) or virtual wallet application.

Third-party interface module 346, can comprise code that when executed by the processor 330, can cause the server computer 300 to facilitate the request for the one-time payment credential after third-party determination module 344 determines the appropriate third-party. The third-party interface module 346 may understand each third party's unique credential algorithm in order to facilitate the request. After facilitating the request, the third-party interface module 346 may receive the one-time payment credential from the third-party and the communication device interface module 342 may relay the one-time payment credential to the communication device 110 (FIG. 1).

QR code module 348, can comprise code that when executed by the processor 330, can cause the server computer 300 to read and interpret a QR code generated by, for example, the access device 120 (FIG. 1). The QR code module 348 may interface with camera 220 to capture or “scan” a presented QR code on e.g., the access device 120 (FIG. 1). Upon capturing or scanning the presented QR code, the QR code module 348 [can interpret the QR code and convert it to useful information. For example, the QR code module 348 can interpret a QR code scanned off an access device and determine the relevant transaction information associated with the transaction (e.g., payment amount, merchant information, coupon information, etc.).

It can be appreciated that the server computer 300 may also herein be referred to as a mobile platform server computer. In some cases, the server computer 300 may be a gateway for the communication device 110 and/or may be operated by a mobile network operator (MNO).

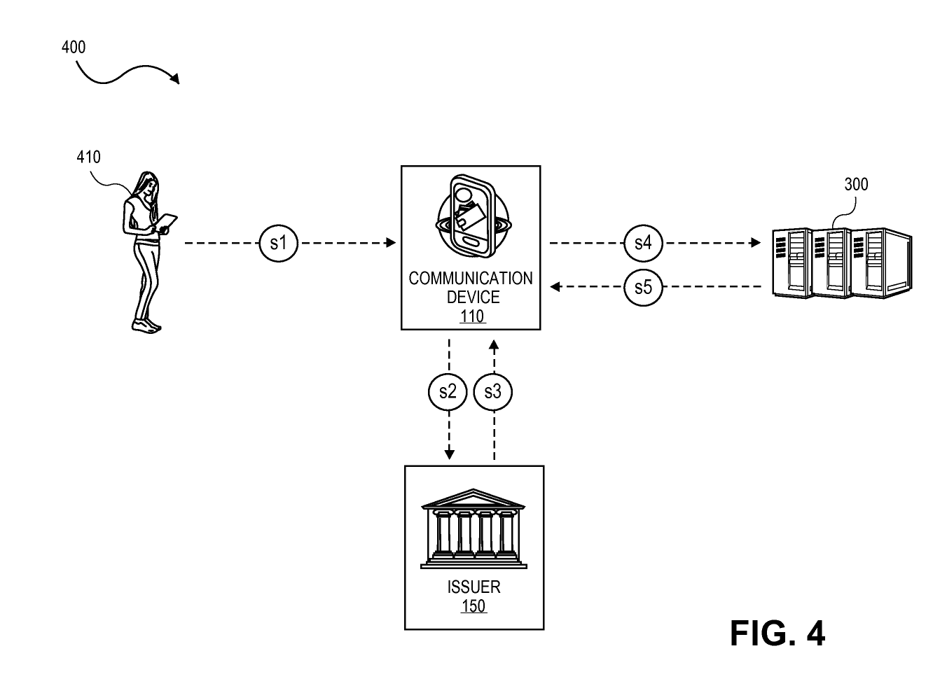

FIG. 4 is a flow diagram 400 of consumer enrollment with a mobile payment platform, in accordance with some embodiments of the invention. The method can be performed by processing logic that may comprise hardware (circuitry, dedicated logic, etc.), software (such as is run on a general purpose computing system or a dedicated machine), firmware (embedded software), multiple systems or any combination thereof. Also, each of the entities in FIG. 4 may operate one or more computers. For example, the issuer 150 may operate an issuer computer.

FIG. 4 shows a user 410, a communication device 110, a mobile platform server computer 300, and an issuer 150. In some embodiments, FIG. 4 may also include an acquirer (not shown) and a payment processor network (not shown) with the acquirer and payment processor network communicatively coupled to the issuer 150, as shown in FIG. 1. The embodiment in FIG. 4 illustrates how a user may enroll with the mobile platform server computer 300 enabling access to temporary credential data. At step s1, the consumer 410 downloads an application to his/her communication device 110. In some embodiments, the communication device 110 may be a smartphone device. The application may be a digital wallet application configured to store a plurality of virtual payment cards held by the user 410. Upon downloading and installing the digital wallet application to the consumer device 110, the user 410 may locally install the application on the communication device 110 via its operating system. The user 410 may then begin adding his/her payment cards to the application for future use.

At step s2, upon adding a payment card (or account data associated with a payment card) to the downloaded application on the communication device 110, the communication device 110 may communicate a consumer authentication message to the issuer 150. The consumer authentication message may include online banking credentials (e.g., a username and password) associated with the payment card so that the issuer 150 can authenticate the consumer 410.

At step s3, after receiving the consumer authentication message, the issuer 150 may communicate a consumer authentication response message to the communication device 110. The consumer authentication response message may be sent to the communication device 110 when the issuer 150 determines that the user 410 is an authenticated user of the payment card and the received online banking credentials associated with the payment card are verified. The online banking credentials may be verified against a database on a computer residing within the issuer 150.

At step s4, upon receiving the consumer authentication response from the issuer 150, the communication device 110 registers with the mobile platform server computer 300. The communication device 110 may transmit payment card details to the mobile platform server computer 300 for registration. The mobile platform server computer 300 may then map the payment card details to the issuer 150 in a mapping or routing table, for example, the routing table database 350 (FIG. 3). That is, the particular payment card used for registration with the mobile platform server computer 300 may be mapped to the issuer 150 associated with the payment card. Additionally, the mobile platform server computer 300 may use a unique device identifier (e.g., a phone number) associated with the communication device 100 and the application (e.g., digital wallet application) to map the payment card details to the issuer 150 in the mapping or routing table, for example by performing a lookup request. Furthermore, the mobile platform server computer 300 may maintain a “consumer authentication flag” based on validation of online banking credentials associated with the payment card.

At step s5, upon the mobile platform server computer 300 registering the user's 410 payment card and its associated details with the issuer 150, the mobile platform server computer 300 may communicate an indication of successful registration to the consumer device 110. The consumer device 110 may display an indication of successful registration with the mobile platform server computer 300 to the user 410. For example, the communication device 110 may display, on its display device, the following pop-up notification: “Your payment card ending in 1532 has been successfully registered with the mobile platform.”

In other embodiments, instead of the mobile communication device 110 providing the payment card details to the server computer 100, the issuer 150 may provide the payment card credentials and any information about the mobile communication device 110 to the server computer 300 directly, without passing through the mobile communication device 110.

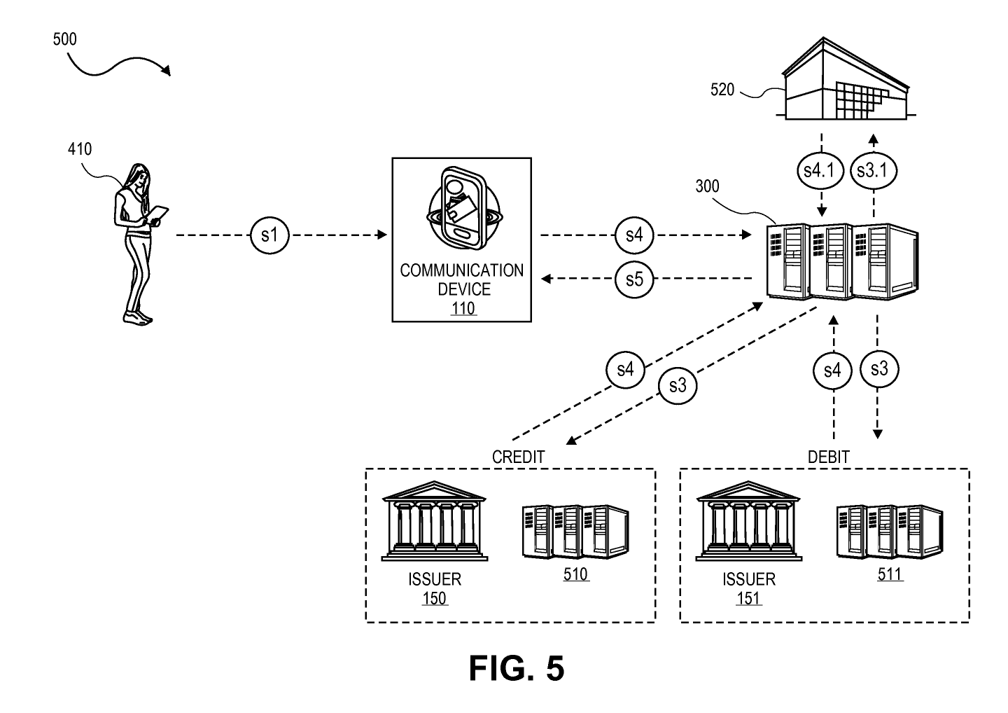

FIG. 5 is a flow diagram 500 of a payment credential request to a mobile payment platform, in accordance with some embodiments of the invention.

FIG. 5 shows a user 410, a communication device 110, a mobile platform server computer 300, a first issuer 150, a first issuer processor 510, a second issuer 151, and a second issuer processor 511. In some embodiments, FIG. 1 may also include an acquirer (not shown) and a payment processor network (not shown) with the acquirer and payment processor network communicatively coupled to either or both of the issuers. The embodiment in FIG. 5 illustrates how the mobile platform server computer 300 routes payment card details to an appropriate issuer to obtain payment credentials.

At step s1, the user 410 may open and login to an application (e.g., digital wallet application) on his/her communication device 110. The application may store payment card details for a plurality of payment cards. The payment cards may include, but are not limited to, credit cards, debit cards, store cards, prepaid cards, etc. The payment cards may be virtual instead of real cards. The user may select a prepaid card stored within the digital wallet application, for example, at a merchant. The user may then initiate a payment transaction at that merchant.

At step s2, the communication device 110 communicates with the mobile platform server computer 300 and requests a unique one-time payment credential to use for the payment transaction. It can be appreciated that the user may have previously enrolled with the mobile platform server computer as described above with respect to FIG. 4. The request for the unique one-time payment credential may include payment card details and other information associated with the user 410.

At step s3, after receiving the request for a unique one-time payment credential from the communication device 110, the mobile platform server computer routes the request to an appropriate issuer based on the mapping or routing table described above. The mapping or routing table within the routing table database 350 (FIG. 3) may contain information pertaining to an issuer associated with each payment card registered with the mobile platform server computer 300. The mobile platform server computer 300 can support multiple issuer programs. That is, the mobile platform server computer 300 may store information pertaining to a plurality of payment cards for a plurality of users 110 and may support a plurality of issuers. The mobile platform server computer 300 may also include information pertaining to each issuer, such as the ability to understand unique algorithms used for unique payment credential generation by the issuer. Additionally, the mobile platform server computer may be integrated with a plurality of issuer processors associated with the plurality of issuers.

In an example, if the user 410 indicates that he/she wishes to use a particular credit card with an account number ending in 5262, the mobile platform server computer 300 may route the request for the one-time payment credential to the first issuer processor 510 associated with the first issuer 150. It can be appreciated that the first issuer 150 may be the issuer for the credit card ending in 5262. Further, it can also be appreciated that the data sent for the one-time payment credential request routed by the mobile platform server computer 300 to the first issuer processor 510 may be formatted such that it conforms to the requirements and encoding scheme of the first issuer processor 510. For example, the request may be formatted to adhere to a particular or unique message format used by the issuer processor 510. As such, the digital wallet application running on the communication device 110 may not be required to have information about the unique data requirements for each of the plurality of issuers. Rather, the application running on the communication device 110 may simply need to communicate with only the mobile platform server computer 300 in order to request a one-time payment credential from the issuer.

In another example, if the user 410 indicates that he/she wishes to use a particular debit card ending in 5821, the mobile platform server computer 300 may route the request for the one-time payment credential to the second issuer processor 511 associated with the second issuer 151. The second issuer 151 may be the issuer for the debit card with an account number ending in 5821. Further, it can also be appreciated that the data sent for the one-time payment credential request routed by the mobile platform server computer 300 to the issuer processor 511 may be formatted such that it conforms to the requirements of the issuer processor 511.

At step s4, the mobile platform server computer 300 may receive a response, from the issuer processor, to the one-time payment credential request. Using the examples above, in the case of the 5262 credit card, the mobile platform server computer 300 may receive a response from the first issuer processor 510. In the case of the 5821 debit card, the mobile platform server computer 300 may receive a response from the second issuer processor 511. The response may include the one-time payment credential associated with the payment card. An example of the one-time payment credential is a generated payment token. In some embodiments, the one-time payment credential may be a coupon associated with the issuer or a merchant, described in further detail below. It can be appreciated that the one-time payment credential is unique to the payment transaction and any subsequent payment transactions may require a request for a new one-time payment credential.

At step s3.1, the mobile platform server computer 300 may communicate with a third-party coupon provider 520 (or computer operated by it) to determine whether the user 410 is eligible for any discounts. The mobile platform server computer 300 may transmit the payment card details to the coupon provider 520 for this determination. For example, if the user is using a store card with a loyalty program, the mobile platform server computer 300 may communicate with a third-party coupon provider 520 associated with the merchant for which the store card is issued. The mobile platform server computer 300 may store information about a plurality of third parties to this extent. The coupon provider 520 may also be associated with the issuer and may facilitate a loyalty program for the issuer. In a similar fashion, the coupon provider 520 may indicate whether the user 410 is eligible for any promotions through the issuer 150.

At step 4.1, the coupon provider 520 may respond to the inquiry by the mobile platform server computer 300 with the appropriate coupon/promotion information. The mobile platform server computer 300 may embed this coupon/promotion information to the payment credential response described with respect to step s5, below.

At step s5, the mobile platform server computer 300 may transmit the received one-time payment credential (possibly encoded with coupon/promotion data) to the communication device 110. In some embodiments, the mobile platform server computer 300 may process or otherwise alter the one-time payment credential prior to transmitting the one-time payment credential to the communication device 110. In some embodiments, the communication device 110 may generate a QR code using the data associated with the one-time payment credential. The QR code may be used in conjunction with an access device (e.g., a POS terminal) to complete the payment transaction. After the payment transaction is completed, the communication device 110 and the mobile platform server computer 300 may delete any data associated with the received one-time payment credential.

Once the one-time payment credential such as a payment token is obtained by the communication device 110, it may be used in any suitable manner. For example, referring back to FIG. 1, the payment credential may be passed from the communication device 110 to the access device 120 operated by the merchant 125. The access device 120 may then generate an authorization request message that is passed from the merchant 125 and to the issuer via the acquirer 130 and the payment processing network 140. The issuer 150 may then receive the payment token and may then determine the real account number associated with the payment token, and may then process the transaction based upon the real account number.

The issuer 150 may then approve of the transaction if there are sufficient funds or credit in the consumer's account, and may then generate an authorization response message. This message may then be transmitted back to the access device 120 via the acquirer 130 and the payment processing network 140. In some cases, the issuer 150 may substitute the payment token for the real account number in the authorization response message.

At the end of the day or at some other predetermined time interval, a clearing and settlement process can occur between the acquirer 130 and the issuer 150 via the payment processing network 140.

In other embodiments, the payment processing network 140 may be the provider of the temporary credential or payment token instead of the issuer 150. In such cases, the payment processing network 140 remove the temporary credential or payment token from the authorization request message and may substitute the real account number for the temporary credential or payment token before forwarding an authorization request message to the issuer 150 or forwarding an authorization response message to the merchant 125.

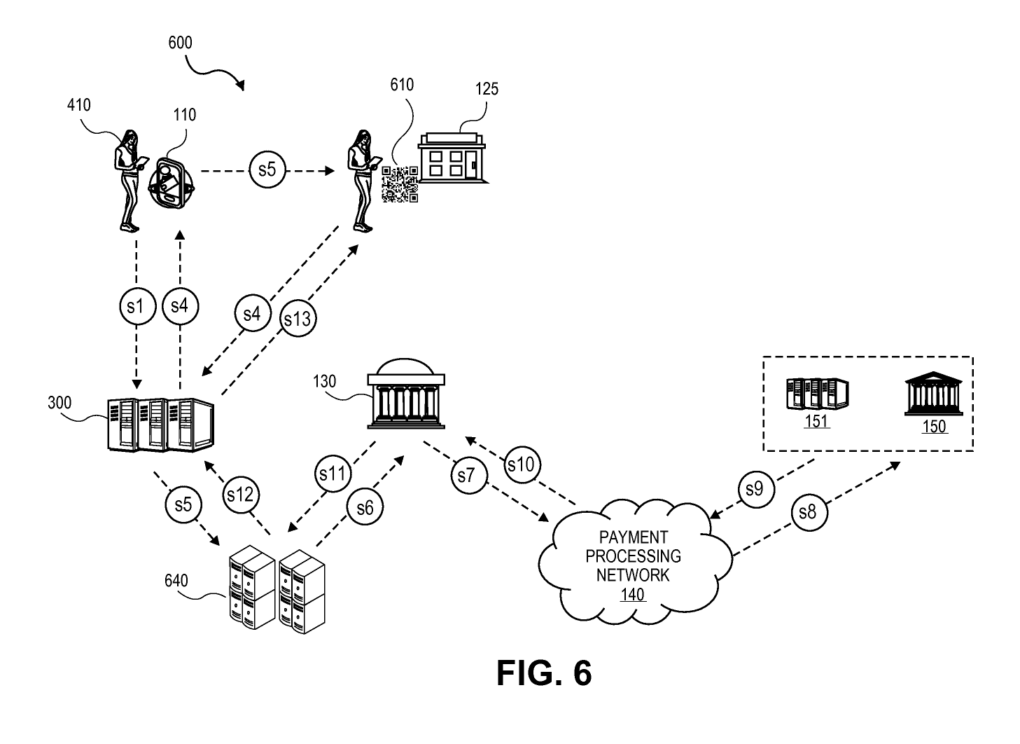

FIG. 6 is a flow diagram 600 illustrating steps of a payment transaction using a QR code 610 with the mobile payment platform, in accordance with some embodiments of the invention.

FIG. 6 shows a user 410, a communication device 110, a mobile platform server computer 300, a QR code 610 displayed on the communication device 110, an issuer 150, an issuer processor 151, a payment gateway 640, a payment processing network 140, and an acquirer 130. The embodiment in FIG. 6 illustrates how a user 410 may use a QR code to checkout at a merchant 125.

At step s1, the user 410 may open and login to an application (e.g., digital wallet application) on his/her communication device 110. The digital wallet application may store payment card details for a plurality of payment cards. The payment cards may include, but are not limited to, credit cards, debit cards, store cards, prepaid cards, etc. The user 410 may select an option within the application to pay using a QR code. The communication device 110 may then request a one-time payment credential from the mobile platform server computer 300.

At step s2, in response to the request for the one-time payment credential, the mobile platform server computer 300 may respond to the communication device 110 with the one-time payment credential. In this example, the one-time payment credential may be credential data that can be used to generate a QR code. The mobile platform server computer 300 may determine this data from stored information about the issuer of the payment card and the payment card details themselves. Thus, the communication device 110 need not communicate directly with the issuer 150 in order to obtain the one-time payment credential used to generate the QR code 610. It can be appreciated that a separate bank identification number (BIN) may be used as part of the one-time payment credential.

At step s3, the application on the communication device 110 may render or generate a QR code 610 from the data received in the one-time payment credential sent by the mobile platform server computer 300. Upon generating the QR code 610, the application may display the generated QR code 610 on the display of the communication device 110.

At step s4, the user 410 may scan the generated QR code 610 at an access device, such as a POS terminal. The user 410 may scan the QR code 610 by holding the display of the communication device 110 at a scanner of the access device at the merchant 125. Upon scanning the QR 610, the access device may transmit data obtained from scanning the QR code 610 to the mobile platform server computer 300. The data scanned from the QR code 610 may include the user's payment card details. The data may also include data associated with the user 410 of the payment card. In some embodiments, the access device at the merchant 125 may keep an “always-on” connection, via communication channel, with the mobile platform server computer 300.

At step s5, the mobile platform server computer 300 may translate the data from the scanned QR code 610 that was received from the access device to registered payment card data. The registered payment card data may include a primary account number (PAN) of the payment card. The registered payment card data may also include other details about the payment card that may be pertinent to the payment transaction. Upon translating the data from the QR code 610 to the payment card details, the mobile platform server computer 300 may transmit the registered payment card details to a payment gateway 640. In some embodiments, the payment gateway 640 may reside within the payment processing network 140, while in other embodiments the payment gateway 640 may reside external to the payment processing network 140.

At step s6, the payment gateway 640 may transmit a standard authorization request message that includes the payment card details to an acquirer 130. The acquirer 130 may be associated with the merchant 125. At step s7, the authorization request message is forwarded by the acquirer 130 to the payment processing network 140. At step s8, the payment processing network 140 may forward the authorization request message to the issuer 150. In some embodiments, the payment processing network 140 may perform a risk analysis on the payment transaction based on data received in the authorization request message prior to forwarding the authorization request message to the issuer 150.

At step s9, the issuer 410 may perform risk analysis on the payment transaction based on data received in the authorization request message. The issuer 150 may then generate an authorization response message indicating either that the payment transaction is approved or denied. The authorization response message is transmitted from the issuer 150 to the payment processing network 140. At step s10, the payment processing network forwards the authorization response message to the acquirer 130. At step s11, the acquirer may forward the authorization response message to the payment gateway 640. At step s12, the payment gateway 640 may provide notification to the mobile platform server computer 300 that the payment transaction has either been approved or denied. At step s13, the mobile platform server computer 300 may notify the access device at the merchant 125 whether the payment transaction has either been approved or denied. If the payment transaction has been authorized, the access device may indicate that the payment transaction is approved and the merchant 125 may allow the user 410 to complete checkout. Otherwise, the access device may indicate that the payment transaction is denied and the merchant 125 may prevent the user 410 from completing checkout. In some embodiments, the access device may provide a receipt for checkout to the user 410 and may obtain a signature from the user 410.

At the end of the day, or any other suitable time interval, a clearing and settlement process, as described above, may take place between the acquirer and the issuer.

The embodiments described with respect to FIG. 6 have advantages in that the server computer 300 can provide temporary payment credentials on behalf of a number of different third party credential providers. In this regard, the routing table database that was described above, may additionally include actual temporary payment credentials stored in the database, and the server computer 300 may function as a token vault.

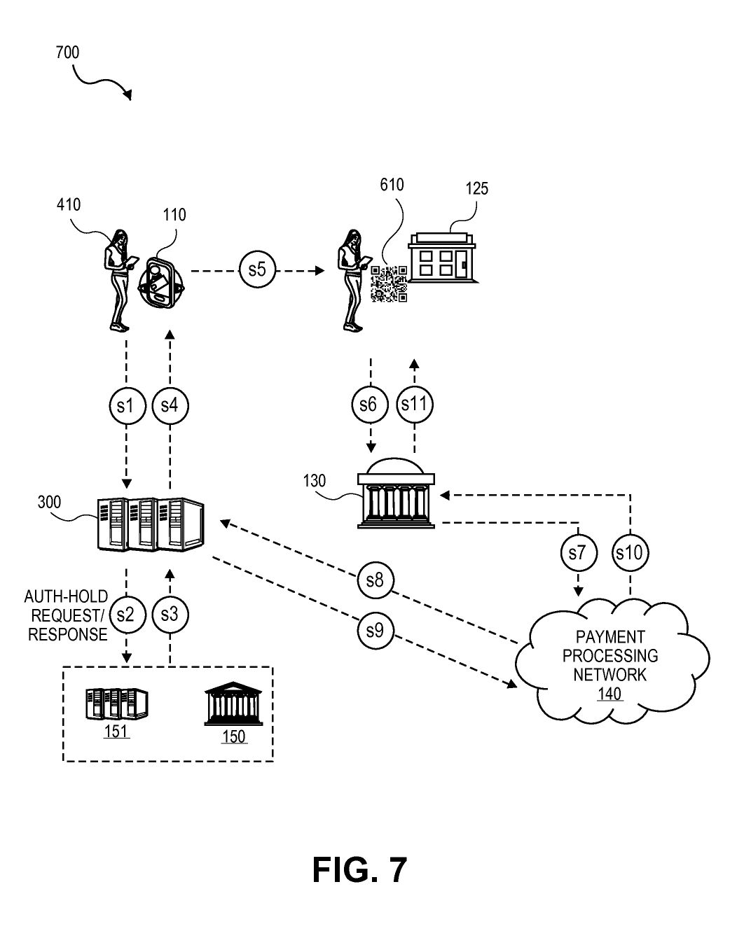

FIG. 7 is a flow diagram 700 illustrating steps of an alternative embodiment for a payment transaction using a QR code 610 with the mobile payment platform, in accordance with some embodiments of the invention.

FIG. 7 shows a user 410, a communication device 110, a mobile platform server computer 300, a QR code 610 displayed on the communication device 110, an issuer 150, an issuer processor 151, a payment processing network 140, and an acquirer 130. The embodiment in FIG. 7 illustrates an alternative embodiment to that described in FIG. 6 for how a user 410 may use a QR code 610 to checkout at a merchant 125.

At step s1, the user 410 may open and login to an application (e.g., digital wallet application) on his/her communication device 110. The application may store payment card details for a plurality of payment cards. The payment cards may include, but are not limited to, credit cards, debit cards, store cards, prepaid cards, etc. The user may select an option within the application to pay using a QR code 610. The communication device 110 may then request a one-time payment credential from the mobile platform server computer 300.

At step s2, in response to the request for the one-time payment credential, the mobile platform server computer 300 may transmit an authorization hold request to the issuer 150. The authorization hold request may be a request to the issuer 150 of the payment card to place a hold for a predetermined amount on the user's 410 payment card account. The predefined amount may be a nominal amount, a predetermined value (e.g. $50), or the amount for the payment transaction initiated by the user 410. In some embodiments, the issuer 150 or payment processing network 140 may determine the appropriate hold amount. The mobile platform server computer 300 may determine the appropriate issuer 150 for the payment transaction from the payment card details received in the one-time payment credential request. Thus, the communication device 110 need not communicate directly with the issuer 150.

The benefit of sending the hold request to the issuer 150 by the server computer 300 is that an amount may be reserved for the issued temporary payment credential on the payment account associated with the real account number. For example, if an account has $500 in credit available, and if the temporary credential that is requested is for $100, then the a hold may be placed on the account so that the user is unable to spend more than $400 using the real account number. This ensures that the issued payment credential is valid.

At step s3, in response to receiving the authorization hold request, the issuer 150 may transmit an authorization hold response to the mobile platform server computer 300. The authorization hold response may indicate that a hold on funds for the appropriate amount has been placed on the user's 410 payment card account.

At step s4, the mobile platform server computer 300 may respond to the communication device 110 with the one-time payment credential. In this example, the one-time payment credential may be credential data that can be used to generate a QR code. The mobile platform server computer 300 may determine this data from stored information about the issuer of the payment card and the payment card details themselves. Thus, the communication device 110 need not communicate directly with the issuer 150 in order to obtain the one-time payment credential used to generate the QR code 610. It can be appreciated that the mobile platform server computer 300 may be assigned a unique BIN. In some embodiments, the mobile platform server computer may serve as an “issuer processor” for issuing the one-time payment credentials. In some embodiments, the mobile platform server computer 300 may be integrated with the issuer processor 150.

At step s5, the application on the communication device 110 may render or generate a QR code 610 from the data received in the one-time payment credential sent by the mobile platform server computer 300. Upon generating the QR code 610, the application may display the generated QR code 610 on the display of the communication device 110.

At step s6, the user 410 may scan the generated QR code 610 at an access device at the merchant 125, such as a POS terminal. The user 610 may scan the QR code 610 by holding the display of the communication device 110 at a scanner of the access device. Upon scanning the QR code 610, the access device may transmit data obtained from scanning the QR code 610 to the acquirer 130 in the form of a standard authorization request message using the one-time payment credential. In this embodiment, since the authorization request message includes the one-time payment credential, the authorization request message may not include the PAN. The data in the authorization request message may also include data associated with the user 410 of the payment card and merchant data. The acquirer 130 may be associated with the merchant 125.

At step s7, the authorization request message is forwarded by the acquirer 130 to the payment processing network 150. At step s8, the payment processing network 150 forward the authorization request message to the mobile platform server computer 300. In some embodiments, the payment processing network 150 may perform a risk analysis on the payment transaction based on data received in the authorization request message prior to forwarding the authorization request message to the mobile platform server computer 300.

At step s9, the mobile platform server computer 300 may perform risk analysis on the payment transaction based on data received in the authorization request message. The mobile platform server computer 300 may then generate an authorization response message indicating either that the payment transaction is approved or denied. The authorization response message is transmitted from the mobile platform server computer 300 to the payment processing network 150. In this sense, the mobile platform server computer 300 may act on behalf of the issuer 150. As noted above, the mobile platform server computer 300 previously sent a hold request so that it can determine if the requested transaction amount is greater than the previously requested hold amount. If it is more than the requested hold amount, then the transaction may be denied. If it is less than the requested hold amount, then the transaction may be approved.

At step s10, the payment processing network forwards the authorization response message to the acquirer 130. At step s11, the acquirer 130 may forward the authorization response message to the access device at the merchant 125. The authorization response message may indicate to the access device at the merchant 125 whether the payment transaction has either been approved or denied. If the payment transaction has been authorized, the access device may indicate that the payment transaction is approved and the merchant 125 may allow the user 410 to complete checkout. Otherwise, the access device may indicate that the payment transaction is denied and the merchant 125 may prevent the user 410 from completing checkout. In some embodiments, the access device may provide a receipt for checkout to the user 410 and may obtain a signature from the user 410.

After the authorization request message is sent by the server computer 300 to the merchant 125, the issuer 150 may be notified of the approved transaction amount. Further, in some cases, the previously requested account hold may be automatically released if the payment credential is a one-time credential.

At the end of the day, or any other suitable time interval, a clearing and settlement process, as described above, may take place between the acquirer 130 and the issuer 150, using a payment processing network.

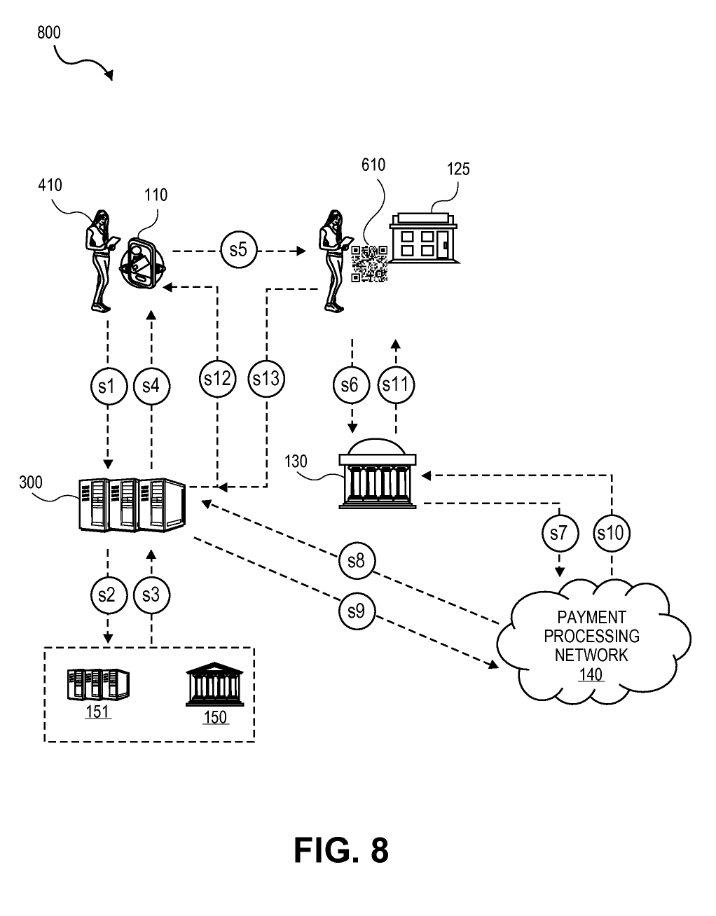

FIG. 8 is a flow diagram 800 illustrating steps of an alternative embodiment for a payment transaction using a QR code 610 with the mobile payment platform, in accordance with some embodiments of the invention. The method can be performed by processing logic that may comprise hardware (circuitry, dedicated logic, etc.), software (such as is run on a general purpose computing system or a dedicated machine), firmware (embedded software), multiple systems or any combination thereof.

FIG. 8 shows a user 410, a communication device 110, a mobile platform server computer 300, a QR code 610 displayed on the communication device 110, an issuer 150, an issuer processor 151, a payment processing network 140, and an acquirer 130. The embodiment in FIG. 8 illustrates an alternative embodiment to that described in FIG. 7 for how a user 410 may use a QR code 610 to checkout at a merchant 125.

At step s1, the user 410 may open and login to an application (e.g., digital wallet application) on his/her communication device 110. The application may store payment card details for a plurality of payment cards. The payment cards may include, but are not limited to, credit cards, debit cards, store cards, prepaid cards, etc. The user may select an option within the application to pay using a QR code 610. The communication device 110 may then request a one-time payment credential from the mobile platform server computer 300.

At step s2, in response to the request for the one-time payment credential, the mobile platform server computer 130 may transmit an authorization hold request to the issuer 150. The authorization hold request may be a request to the issuer 150 of the payment card to place a hold for a predetermined amount on the user's 410 payment card account. The predefined amount may be a nominal amount, a predetermined value (e.g. $50), or the amount for the payment transaction initiated by the user 410. In some embodiments, the issuer 150 or PPN 140 may determine the appropriate hold amount. The mobile platform server computer 300 may determine the appropriate issuer 150 for the payment transaction from the payment card details received in the one-time payment credential request. Thus, the communication device 110 need not communicate directly with the issuer 150.

At step s3, in response to receiving the authorization hold request, the issuer 150 may transmit an authorization hold response to the mobile platform server computer 300. The authorization hold response may indicate that a hold on funds for the appropriate amount has been placed on the user's 410 payment card account.

At step s4, the mobile platform server computer 300 may respond to the communication device 110 with the one-time payment credential. In this example, the one-time payment credential may be credential data that can be used to generate a QR code. The mobile platform server computer 300 may determine this data from stored information about the issuer of the payment card and the payment card details themselves. Thus, the communication device 110 need not communicate directly with the issuer 150 in order to obtain the one-time payment credential used to generate the QR code 610. It can be appreciated that the mobile platform server computer 300 may be assigned a unique BIN. In some embodiments, the mobile platform server computer may serve as an “issuer processor” for issuing the one-time payment credentials. In some embodiments, the mobile platform server computer 300 may be integrated with the issuer processor 151.

In some embodiments, the one-time payment credential may be a token that is only authorized for a predetermined the value. The predetermined value could be the hold amount sent in the authorization hold request message. In some embodiments, the predetermined value could also be greater than the hold amount sent in the authorization hold request message.

At step s5, the application on the communication device 110 may render or generate a QR code 610 from the data received in the one-time payment credential sent by the mobile platform server computer 300. Upon generating the QR code 610, the application may display the generated QR code 610 on the display of the communication device 110.

At step s6, the user 410 may scan the generated QR code 610 at an access device, such as a POS terminal. The user 410 may scan the QR code 610 by holding the display of the communication device 110 at a scanner of the access device. Upon scanning the QR code 610, the access device may transmit data obtained from scanning the QR code 610 to the acquirer 130 in the form of a standard authorization request message using the one-time payment credential. In this embodiment, since the authorization request message includes the one-time payment credential, the authorization request message may not include the PAN. The data in the authorization request message may also include data associated with the user 410 of the payment card and merchant data. The acquirer 130 may be associated with the merchant 125.

At step s7, the authorization request message is forwarded by the acquirer 130 to the payment processing network 140. At step s8, the payment processing network 140 may forward the authorization request message to the mobile platform server computer 300. In some embodiments, the payment processing network 140 may perform a risk analysis on the payment transaction based on data received in the authorization request message prior to forwarding the authorization request message to the mobile platform server computer 300.

At step s9, the mobile platform server computer 300 may perform risk analysis on the payment transaction based on data received in the authorization request message. The mobile platform server computer 300 may then generate an authorization response message indicating either that the payment transaction is approved or denied. The authorization response message is transmitted from the mobile platform server computer 300 to the payment processing network 150. In this sense, the mobile platform server computer 300 may act on behalf of the issuer 150.

At step s10, the payment processing network forwards the authorization response message to the acquirer 130. At step s11, the acquirer 130 may forward the authorization response message to access device at the merchant 125. The authorization response message may indicate to the access device at the merchant 125 whether the payment transaction has either been approved or denied. If the payment transaction has been authorized, the access device may indicate that the payment transaction is approved and the merchant 125 may allow the user 410 to complete checkout. Otherwise, the access device may indicate that the payment transaction is denied and the merchant 125 may prevent the user 410 from completing checkout. In some embodiments, the access device may obtain a signature from the user 410.

At step s12, upon completing the payment transaction, the access device at the merchant 125 may electronically deliver a receipt to the mobile platform server computer 300 and to the communication device 110 (step s13). The receipt may include details pertaining to the payment transaction and may also indicate that a QR code 610 was used to imitate the payment transaction. As such, the receipt may not include the PAN of the payment card used for the transaction.

After the authorization request message is sent by the server computer 300 to the merchant 125, the issuer 150 may be notified of the approved transaction amount. Further, in some cases, the previously requested account hold may be automatically released if the payment credential is a one-time credential.

At the end of the day, or any other suitable time interval, a clearing and settlement process, as described above, may take place between the acquirer 130 and the issuer 150, using a payment processing network.

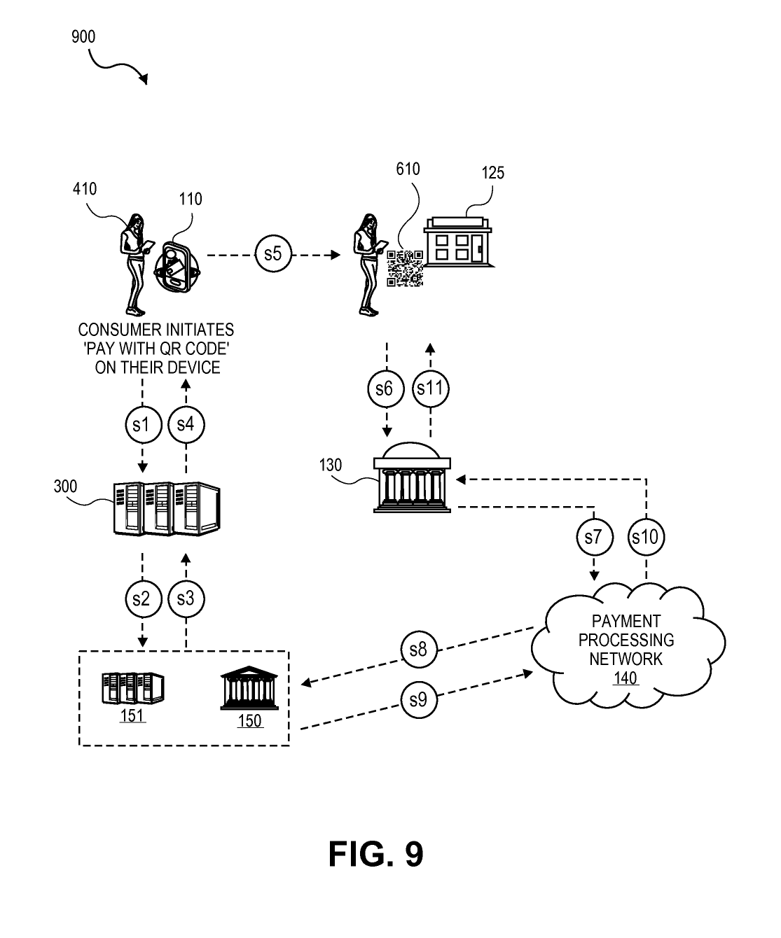

FIG. 9 is a flow diagram 900 illustrating steps of an alternative embodiment for a payment transaction using a QR code 610 with the mobile payment platform, in accordance with some embodiments of the invention. The method can be performed by processing logic that may comprise hardware (circuitry, dedicated logic, etc.), software (such as is run on a general purpose computing system or a dedicated machine), firmware (embedded software), multiple systems or any combination thereof.

FIG. 9 shows a user 410, a communication device 110, a mobile platform server computer 300, a QR code 610 displayed on the communication device 110, an issuer 150, an issuer processor 151, a payment processing network 140, and an acquirer 130. The embodiment in FIG. 9 illustrates an alternative embodiment to that described in FIG. 7 for how a user 410 may use a QR code 610 to checkout at a merchant 125.

At step s1, the user 410 may open and login to an application (e.g., digital wallet application) on his/her communication device 110. The application may store payment card details for a plurality of payment cards. The payment cards may include, but are not limited to, credit cards, debit cards, store cards, prepaid cards, etc. The user may select an option within the application to pay using a QR code 610. The communication device 110 may then request a one-time payment credential from the mobile platform server computer 300.

At step s2, the mobile platform server computer 300 may forward the one-time payment credential request to the issuer 150. The mobile platform server computer 300 may determine the appropriate issuer 150 for the payment transaction from the payment card details received in the one-time payment credential request. Thus, the communication device 110 need not communicate directly with the issuer 150.

At step s3, in response to receiving the one-time payment credential request, the issuer 150 may transmit a one-time payment credential response to the mobile platform server computer 300. The one-time payment credential response may indicate a one-time payment credential to be used for the payment transaction. For example, the one-time payment credential response may be a payment token. In some embodiments, the one-time payment credential may also include a special offer from the issuer 150. For example, if the issuer employs a rewards program and the user 410 is eligible for a reward, the one-time payment credential may include this reward. For example, the one-time payment credential may indicate to the mobile platform server computer 300 that the user is eligible for a $5 discount on the payment transaction.

At step s4, the mobile platform server computer 300 may respond to the communication device 110 with the one-time payment credential. In this example, the one-time payment credential may be credential data that can be used to generate a QR code 610. The mobile platform server computer 300 may determine this data from stored information about the issuer of the payment card and the payment card details themselves. Thus, the communication device 110 need not communicate directly with the issuer 300 in order to obtain the one-time payment credential used to generate the QR code 610. It can be appreciated that the mobile platform server computer 300 may be assigned a unique BIN in some embodiments. In some embodiments, the mobile platform server computer may serve as an “issuer processor” for issuing the one-time payment credentials. In some embodiments, the mobile platform server computer 300 may be integrated with the issuer processor 151.

At step s5, the application on the communication device 110 may render or generate a QR code 610 from the data received in the one-time payment credential sent by the mobile platform server computer 300. Upon generating the QR code 610, the application may display the generated QR code 610 on the display of the communication device 110.

At step s6, the user 110 may scan the generated QR code 610 at an access device, such as a POS terminal. The user 110 may scan the QR code 610 by holding the display of the communication device 110 at a scanner of the access device. Upon scanning the QR code 610, the access device may transmit data obtained from scanning the QR code 610 to the acquirer 130 in the form of a standard authorization request message using the one-time payment credential. In this embodiment, since the authorization request message includes the one-time payment credential, the authorization request message may not include the PAN. The data in the authorization request message may also include data associated with the user 410 of the payment card and merchant data. The acquirer 130 may be associated with the merchant 125.

At step s7, the authorization request message is forwarded by the acquirer 130 to the payment processing network 140. At step s8, the payment processing network 140 may forward the authorization request message to the issuer 150. In some embodiments, the payment processing network 130 may perform a risk analysis on the payment transaction based on data received in the authorization request message prior to forwarding the authorization request message to the mobile platform server computer 300. At the issuer 150, the issuer 150 may determine the real account number associated with the payment credential, and may process the transaction using the real account number.

At step s9, the issuer computer 300 may generate an authorization response message indicating either that the payment transaction is approved or denied. The authorization response message is transmitted from the issuer 150 to the payment processing network 140.

At step s10, the payment processing network forwards the authorization response message to the acquirer 130. At step s11, the acquirer 130 may forward the authorization response message to the access device at the merchant 125. The authorization response message may indicate to the access device at the merchant 125 whether the payment transaction has either been approved or denied. If the payment transaction has been authorized, the access device may indicate that the payment transaction is approved and the merchant 125, via the access device, may allow the user 410 to complete checkout. Otherwise, the access device may indicate that the payment transaction is denied and the merchant 125 may prevent the user 410 from completing checkout. In some embodiments, the access device may provide a receipt for checkout to the user 410 and may obtain a signature from the user 410.

At the end of the day, or any other suitable time interval, a clearing and settlement process, as described above, may take place between the acquirer 130 and the issuer 150, using a payment processing network.

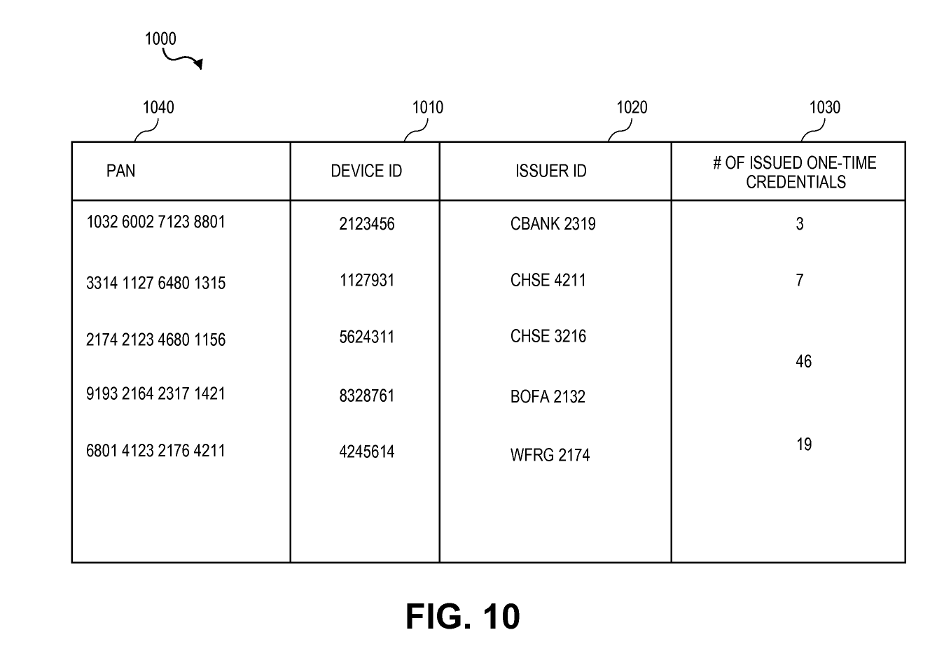

FIG. 10 shows an exemplary routing table 1000 for routing requests for one-time payment credentials to an appropriate third-party, in accordance with some embodiments of the invention. The routing table 1000 may be stored within the routing table database 350 (FIG. 3) of server computer 300 (FIG. 3). The routing table 1000 can include a multitude of information, including information about but not limited to, various issuers, merchants, and communication devices.

The routing table 1000 shows various entries for a device identifier 1010, issuer identifier 1020, a primary account number 1040, and a count of a number of issued one-time credentials 1030 associated with a particular device identifier. The device identifier 1010 may be a unique identifier associated with a communication device 110 (FIG. 1). The issuer identifier 1020 could be an address of the issuer, such as an IP address or other type of address if the payment account numbers have BINs (bank identification numbers) in them. The device identifier 1010 may be provided by the digital wallet application or may encoded on hardware of the communication device 110 (FIG. 1). It could also be a phone number, an IMEI number, a SIM card number or any other number identifying the communication device 110. The server computer may identify the particular communication device 110 (FIG. 1) using the device identifier 1010 and also obtain other pertinent information tied to the particular device (e.g., information about the user, payment card, etc.) The issuer identifier 1020 may be a unique identifier associated with a particular issuer 150 (FIG. 1). The issuer identifier 1020 may identify which issuer a payment card or primary account number is associated with.

The routing table 1000 may be queried by the server computer 300 upon receiving a request for a one-time payment credential. More specifically, the third-party determination module 344 (FIG. 3) may perform a lookup operation on the routing table 1000 by mapping a device identifier 1010 received in a request for the one-time payment credential from the communication device 110 (FIG. 1) to a primary account number associated with the user's 410 payment account. Upon performing the lookup on the routing able 1000, the third-party determination module 344 (FIG. 3) may determine the appropriate issuer identifier 1020 for the issuer associated with the primary account number 1040. The third-party interface module 346 (FIG. 3) may then route the request for the one-time payment credential to the appropriate issuer and receive a response from the issuer with the one-time payment credential. The communication device interface module 342 (FIG. 3) may then relay the one-time payment credential to the communication device 110 (FIG. 1) to use in the payment transaction.

In some embodiments, the routing table 1000 may also contain information about a merchant for when the digital wallet application on the communication device 110 sends a request for a one-time credential for a coupon associated with the merchant, as described above.

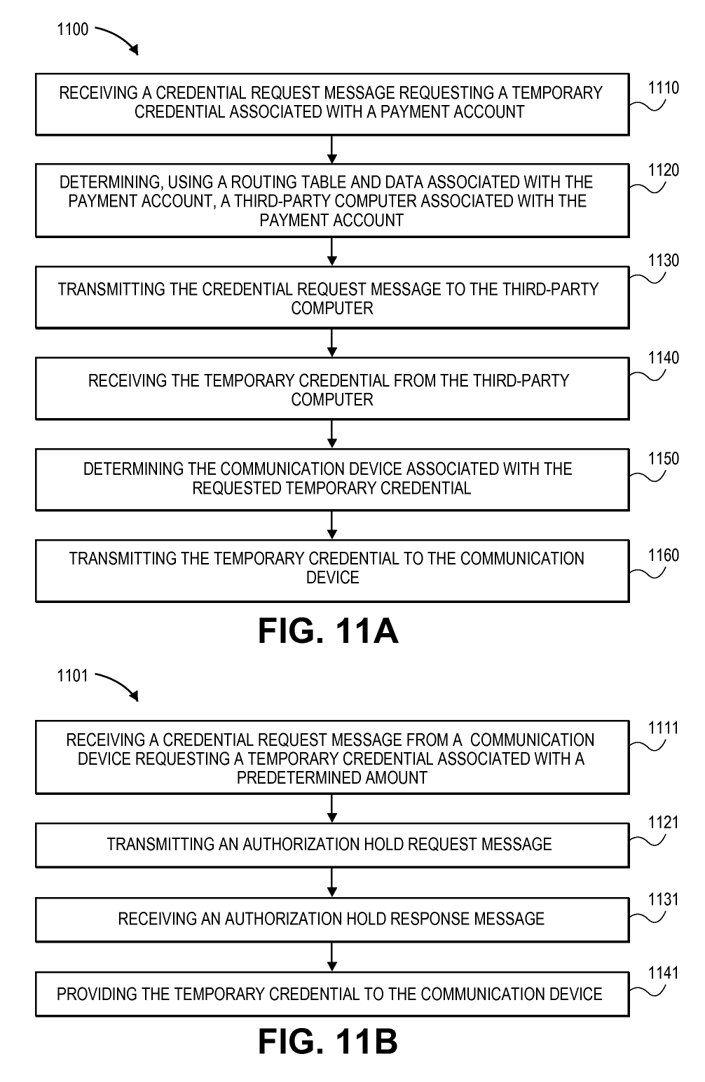

FIG. 11A is a flowchart 1100 of an exemplary method for enrolling an item in a virtual wallet. The method can be performed by processing logic that may comprise hardware (circuitry, dedicated logic, etc.), software (such as is run on a general purpose computing system or a dedicated machine), firmware (embedded software), multiple systems or any combination thereof.

In block 1110, a credential request message requesting a temporary credential associated with a payment account is received by a server computer. The credential request may be received from a communication device. The request for the temporary credential could be a request for a payment token that is a substitute for a payment account number of a payment account associated with a user of the communication device. For example, in FIG. 5, the server computer receives a request for a temporary credential from the user's communication device.

In block 1120, the server computer may determine, using a routing table and data associated with the payment account, a third-party computer associated with the payment account. The third-party computer may be an issuer computer or a merchant computer. For example, in FIG. 5, the server computer determines an appropriate issuer associated with the user's payment account by performing a lookup operation on the routing table stored within the routing table database.

In block 1130, the server computer may transmit the credential request message to the third-party computer. The credential request message may be a request for the credential requested from the communication device in block 1110. The credential request may be formatted in the form of an authorization request message. For example, in FIG. 5, the server computer transmits the credential request message to the issuer computer.

In block 1140, the temporary credential is received, by the server computer, from the third-party computer. For example, in FIG. 5, the server computer receives the temporary credential from the issuer computer.

In block 1150, the communication device associated with the requested temporary credential is determined. For example, in FIG. 5, after the server computer receives the temporary credential from the issuer computer, the server computer determines the communication device associated with the temporary credential.

In block 1160, upon determining the communication device associated with the temporary credential, the temporary credential may be transmitted to the communication device. For example, in FIG. 5, the server computer transmits the temporary credential to the communication device of the user.

In some embodiments, the communication device is a phone that is capable of communicating with a point-of-sale (POS) terminal using an radio frequency (RF) communication channel.

FIG. 11B is a flowchart 1101 of an exemplary method for transmitting a hold request for a predetermined amount. The method can be performed by processing logic that may comprise hardware (circuitry, dedicated logic, etc.), software (such as is run on a general purpose computing system or a dedicated machine), firmware (embedded software), multiple systems or any combination thereof.

In block 1111, a server computer may receive a credential request message from a communication device requesting a temporary credential associated with a predetermined amount. For example, in FIG. 8, the server computer may receive a request for a credential request message from the communication device of the user. In some embodiments, the temporary credential may be a payment token. In some embodiments, the temporary credential may be a payment token of a predetermined value, the authorization hold request may include an amount that is equal to or greater than the predetermined value.

In block 1121, an authorization request message may be transmitted. For example, in FIG. 8, the server computer transmit an authorization hold request message to the issuer associated with the payment account of the user.

In block 1131, an authorization hold response message may be received. For example, in FIG. 8, the server computer receives an authorization hold response message from the issuer.

In block 1141, the temporary credential may be provided to the communication device. For example, in FIG. 8, the server computer sends the temporary credential to the communication device.

The various participants and elements described herein with reference to FIGS. 1-9 may operate one or more computer apparatuses to facilitate the functions described herein. Any of the elements in FIGS. 1-9, including any servers or databases, may use any suitable number of subsystems to facilitate the functions described herein.

Examples of such subsystems or components are shown in FIG. 12. The subsystems shown in FIG. 12 are interconnected via a system bus 1210. Additional subsystems such as a printer 1230, keyboard 1218, fixed disk 1220 (or other memory comprising computer readable media), monitor 1212, which is coupled to display adapter 1214, and others are shown. Peripherals and input/output (I/O) devices, which couple to I/O controller 1224 (which can be a processor or other suitable controller), can be connected to the computer system by any number of means known in the art, such as serial port 1216. For example, serial port 1216 or external interface 1222 can be used to connect the computer apparatus to a wide area network such as the Internet, a mouse input device, or a scanner. The interconnection via system bus allows the central processor 1228 to communicate with each subsystem and to control the execution of instructions from system memory 1226 or the fixed disk 1220, as well as the exchange of information between subsystems. The system memory 1226 and/or the fixed disk 1220 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer and from a communication device, a credential request message requesting a temporary credential associated with a payment account;
determining, by the server computer, using a routing table and data associated with the payment account, a third-party computer associated with the payment account;
transmitting, by the server computer, the credential request message to the third-party computer;
receiving, by the server computer, the temporary credential from the third-party computer;
determining, by the server computer, the communication device associated with the requested temporary credential; and
transmitting, by the server computer, the temporary credential to the communication device.

2. The method of claim 1, wherein the temporary credential is a payment token that is a substitute for a payment account number of the payment account.

3. The method of claim 1, wherein the third party computer is an issuer computer.

4. The method of claim 1, wherein the payment account is associated with a payment card.

5. The method of claim 1, wherein the third-party computer is a merchant computer.

6. The method of claim 1, wherein the communication device is a phone that is capable of communicating with a point-of-sale (POS) terminal using an radio frequency (RF) communication channel.

7. A server computer comprising a processor, and a computer readable medium coupled to the processor, the computer readable medium comprising code, executable by the processor, for implementing a method comprising:
receiving, by the server computer and from a communication device, a credential request message requesting a temporary credential associated with a payment account;
determining, by the server computer, using a routing table and data associated with the payment account, a third-party computer associated with the payment account;
transmitting, by the server computer, the credential request message to the third-party computer;
receiving, by the server computer, the temporary credential from the third-party computer;
determining, by the server computer, the communication device associated with the requested temporary credential; and
transmitting, by the server computer, the temporary credential to the communication device.

8. The server computer of claim 7, wherein the temporary credential is a payment token that is a substitute for a payment account number of the payment account.

9. The server computer of claim 7, wherein the third party computer is an issuer computer.

10. The server computer of claim 7, wherein the payment account is associated with a payment card.

11. The server computer of claim 7, wherein the third-party computer is a merchant computer.

12. The server computer of claim 7, wherein the communication device is a phone that is capable of communicating with a point-of-sale (POS) terminal using an radio frequency (RF) communication channel.

13. A method comprising:
receiving, by a server computer, a credential request message from a communication device requesting a temporary credential associated with a predetermined amount;
transmitting, by the server computer, an authorization hold request message;
receiving, by the server computer, an authorization hold response message; and
providing, by the server computer, the temporary credential to the communication device.

14. The method of claim 13, wherein the temporary credential is a payment token.

15. The method of claim 13, wherein the temporary credential is a payment token of a predetermined value, and wherein the authorization hold request includes an amount that is equal to or greater than the predetermined value.

16. The method of claim 13, further comprising:
receiving an authorization request message comprising the temporary credential; and
transmitting an authorization response message comprising the temporary credential.

17. A server computer comprising a processor, and a computer readable medium coupled to the processor, the computer readable medium comprising code, executable by the processor, for implementing a method comprising:
receiving, by the server computer, a credential request message from a communication device requesting a temporary credential associated with a predetermined amount
transmitting, by the server computer, an authorization hold request message;
receiving, by the server computer, an authorization hold response message; and
providing, by the server computer, the temporary credential to the communication device.

18. The server computer of claim 17, wherein the temporary credential is a payment token.

19. The server computer of claim 17, wherein the temporary credential is a payment token of a predetermined value, and wherein the authorization hold request includes an amount that is equal to or greater than the predetermined value.

20. The server computer of claim 17, wherein the method further comprises:
receiving an authorization request message comprising the temporary credential; and
transmitting an authorization response message comprising the temporary credential.
